(19) United States
(12) Patent Application Publication
(10) Pub. No.: US 2006/0025927 A1
(43) Pub. Date: Feb. 2, 2006

(54) Method of optimally producing and harvesting agricultural products

(76) Inventors: Reed L. Hoskinson, Rigby, ID (US); Raymond K. Fink, Jackson, WY (US); J. Richard Hess, Idaho Falls, ID (US); Randy D. Lee, Idaho Falls, ID (US); Ronald C. Rope, Idaho Falls, ID (US)

Correspondence Address: STEPHEN R. CHRISTIAN;BBWI, PO BOX 1625, IDAHO FALLS, ID, 83415-3899, US

(21) Appl. No.: 10/901,267

(22) Filed: Jul. 27, 2004

(51) Int. Cl. G06F 19/00

(52) U.S. Cl. 702/1

(57) ABSTRACT

A method of optimally producing and harvesting agricultural products is provided. In one exemplary embodiment, the method may include identifying a first crop component, such as grain, and at least a second crop component, which may include a biomass component such as straw. At least one fact is obtained for each of the identified crop components and the facts are analyzed to determine a recipe for application to the agricultural crop. The recipe may include a fertilizing recipe, an irrigation recipe, a recipe for the application of pesticide, or for some other activity. The recipe may be devised to enhance one or all of the identified plant components depending, for example, on current or economical markets associated with each identified plant component.

### GOVERNMENT RIGHTS

The United States Government has rights in the following invention pursuant to Contract No. DE-AC07-99ID13727 between the U.S. Department of Energy and Bechtel BWXT Idaho, LLC.

### BACKGROUND OF THE INVENTION

1. Field of the Invention

The present invention relates generally to methods for optimally producing and harvesting agricultural products. More specifically, the present invention relates to methods for fertilizing and irrigating agricultural lands and harvesting crops therefrom in a manner that optimizes the production and harvest depending on multiple factors including market influences.

2. State of the Art

Types of soil present in an agricultural field are often categorized according to their relative proportions of sand, silt and clay. Although numerous classifications of soil types exist, the classifications of sandy, loam and clay are the main classifications to which the others belong. Due to their composition, sandy soils have the least capacity to hold water and nutrients. Clay soils, on the other hand, have the greatest capacity to hold water and store nutrients. Thus, clay soils generally require the least amount of fertilization. Loam soils are a hybrid classification between sand and clay and consist generally of a friable mixture of varying proportions of clay, silt and sand. Although agricultural fields may not have all three of the main classifications, they typically contain at least two of the three with one classification being dominant. Because each agricultural field contains varying soil types, fertilizing and watering requirements will vary throughout a given field or area.

A conventional field or agricultural area is usually fertilized with a uniform blend of fertilizers. At best, some fields are fertilized according to the variations in the soil types. The three most common nutrients in these fertilizers include nitrogen, potassium and phosphorous. However, applying these nutrients together can be problematic because these nutrients have one effect on the soils to which they are applied while simultaneously having another effect on each other. Moreover, fertilizers often migrate away from the geographical location where they were applied because of drainage, erosion and topographical characteristics of the field. Thus, it is difficult to provide a customized fertilizer blend to a field.

Additionally problematic is the reality of dispensing these fertilizer blends. Presently, a conventional fertilizer dispensing apparatus includes a truck or tractor having a bulk fertilizer storage bin that can distribute large quantities of fertilizer to a field in a relatively short time. However, since soil types often change rapidly and drastically across a singular field, bulk distribution systems are unable to rapidly adjust the distribution of the fertilizer in a manner commensurate with the changes in soil.

Conventional methods of irrigating agricultural fields are also limited in their effectiveness and efficiency. Conventional irrigation methods include flood irrigation and sprinkler irrigation. Both methods attempt to deliver water to the agricultural field in a relatively uniform manner. For example, sprinkler systems are often timed and may be configured to traverse the agricultural field at a specified speed in an effort to evenly distribute the water provided thereby. However, such irrigation methods do not adequately account for the topography of the agricultural field and do not consider the current water content or evaporation rates of the agricultural field. As a result, some areas of the agricultural field may not receive enough water while an excess of water may collect and sit in other areas of the agricultural field. Neither condition is desirable for optimum field usage.

These and other difficulties have been appreciated by the prior art. As such, various attempts have been undertaken to quantify the effects of distributing fertilizer blends and irrigation water across various topographies having wide-ranging erosion and drainage characteristics. The result has been detailed tabular data or charts. However, such data has been limited in its use and effectiveness.

One shortcoming associated with the used of tabular data is that the data is too generalized and not specific enough to an identified agricultural field. Another shortcoming is that this data does not consider the history of a particular field.

Agronomists, or specialists in the agriculture branch of dealing with crop production and soil management, have also appreciated the foregoing problems and have attempted to quantify the effects of fertilizer, erosion and soil type as they relate to crop production. Although useful agronomy data has been generated, the data is frequently generated from closed environments, such as greenhouses and terrariums, and is not completely indicative of “real-world” growing environments.

Agronomists' data has also conventionally been limited in scope. For example, agronomists frequently test soils to ascertain the major constituents of the soil while neglecting the minor constituents. This approach is acceptable so long as the soil is not complex in its composition. For example, if the data conveys that a specific crop grows best at nitrogen levels of 39 parts per million (ppm) and the field is currently 30 ppm, the data recommends that fertilizer having nitrogen in amounts to bring that portion of the field up 9 ppm be introduced to the field. This recommendation, however, does not usually consider other pertinent information such as pH, lime, topography, irrigation, micronutrients, such as magnesium, boron, manganese and sulphur, and other complexities that serve to make each field unique. Thus, if one or more portions of the field has substantial amounts of boron, that field, altogether, might not even be a good place to grow the specified crop. However, failing to take into account additional complexities (such as the presence of boron), if the agronomist's data says 39 ppm of nitrogen to grow the specified crop, then growth of the specified crop is attempted in that field and fertilizer containing nitrogen is added to raise it to the level assumed appropriate. This example also serves to illustrate the problem that the agronomist's data is usually crop-specific and is without capacity to adapt to other crops.

Within the prior art there is a farming discipline known as variable rate technology (VRT) that is used to apply variably blended fertilizer compositions to a field in an attempt to overcome the difficulties associated with bulk distribution systems. In U.S. Pat. Nos. 4,700,895, 5,220,876, 5,355,815 and 5,689,418, all having common assignee Ag-Chem Equipment Co., Inc., of Minnesota, methods and apparatus are described to apply a fertilizer “prescription” unique to each particular agricultural field. In general, these patents teach fertilization of a particular field by: (i) utilizing a soil map, particularized to the field of interest, the soil map being stored onboard a dispensing truck that will be used to distribute the fertilizer; (ii) obtaining “real-time” soil samples from a soil sampler attached to the truck to supplement and update the soil map; and (iii) selectively preparing, in real time, the fertilizer blend from various nutrient bins stored upon the truck before distribution onto the field so as to optimize the fertilizer prescription based on the information obtained from the soil map and the collected soil samples.

These VRT dispensing trucks and methodologies are problematic for a number of reasons. One, the VRT dispensing truck system does not consider the economic worthiness of the fertilizer prescription. For example, if the soil sampler and the stored soil map, together with an associated computer, make a determination that a particular portion of the field has sandy soils and requires extensive fertilization, the truck will automatically distribute the necessary fertilizer blend according to the determination. But, if the determination to fertilize equates to a $15 bag of nitrogen and the current market price for the particular crop being fertilized will only yield an additional $10 of income, a costly economic decision has been made. In other words, it is economically unjustifiable to expend more dollars in fertilizer than will be recovered when selling the harvested crops. Faulty economic decisions compounded over numerous fields over many years could cause financial ruin of a farming operation.

Additionally, if the determination requires the addition of fertilizer without considering other effects, such as topography and drainage, the fertilizer may be applied to an area of the field having substantial run-off. If this happens, the fertilizer may be washed away from its area of intended use before having an opportunity to contribute any nutrients to the soil. The run-off might even cause the fertilizers to flow into neighboring rivers and streams, for example, and create or further contribute to an environmental pollution problem. Such waste could be prevented if better determinations are made about when and where fertilizers are to be applied.

Furthermore, the above-described VRT dispensing truck systems do not consider the history of the particular field being fertilized. The VRT system utilizes a “snapshot” of the field that is taken at the particular time when soil samples are obtained by the truck and analyzed by the associated computer. Although the calculations used by the computer to obtain the proper fertilizer prescription from the snapshot are not described in detail or otherwise taught in the patents, such calculations are implied to be a function of the fertilizers themselves since factors such as topography, exposure, erosion, irrigation methods and other similar data are not specifically discussed or otherwise implied to be associated with the determination of the fertilizer prescription. Nor is there any mention of analyzing the field history in these calculations to ascertain whether the determined soil types exist as a function of previously applied fertilizer or whether the soil types are naturally occurring.

Another inefficiency of conventional VRT systems includes the fact that the fertilizer is distributed by a boom that is much larger in size than the soil sampler mechanism associated with the VRT. Thus, the fertilizer prescriptions are applied to an area which is not fairly represented by the soil sampled such that the determined prescriptions are largely informed guesses based on incomplete information. In other words, economic optimization is not obtained.

The prior art also largely overlooks other worthwhile information such as neighboring fields, irrigation methodologies, predicted market prices of various crops, predicted rainfalls and other similar data.

Additionally, the prior art processes that attempt to optimize fertilizer prescriptions or recipes for an agricultural field are focused on producing the best harvest of a single specified component of a given crop. For example, considering an agricultural field containing a crop of wheat, fertilizers are conventionally prescribed or tailored in an effort to maximize the harvest of wheat grain without considering the possibility of harvesting any additional plant component from the crop.

Accordingly, it is desirous to provide a method for applying fertilizer to an agricultural field that is economically optimized and reflects all available past, present and future information useful in crop production. Additionally, it would be advantageous to provide a method of producing and harvesting multiple components from a crop within a given agricultural field.

### BRIEF SUMMARY OF THE INVENTION

In accordance with one aspect of the invention, a method is provided for producing and harvesting an agricultural crop. The method includes identifying a first crop component for potential production and harvesting and identifying at least a second crop component for potential production and harvesting. At least one fact related to production and harvesting of the first crop component and at least one fact related to production and harvesting of the at least a second crop component are analyzed. The production of the first crop component and the at least a second crop component based on the analysis by determining a recipe for application to the agricultural crop. The recipe may include, for example, a fertilizing recipe, an irrigation recipe or some other activity associated with production of the agricultural crop. The identified crop components may include, for example, a grain component and a biomass component.

In accordance with another aspect of the invention, another method is provided for producing and harvesting an agricultural crop. The method includes obtaining at least one fact related to a first component of the crop and a first analysis is conducted regarding whether a defined action associated with the at least one fact related to the first component may be executed. At least one fact is obtained related to a second component of the crop and a second analysis is conducted regarding whether a defined action associated with the at least one fact related to the second component may be executed. The first analysis is compared with the second analysis and a determination is made regarding an action to be taken with respect to the agricultural crop based on the comparing the first analysis with the second analysis.

In accordance with another aspect of the invention, a further method is provided for producing and harvesting an agricultural crop. The method includes obtaining at least one fact related to a grain component of the crop and obtaining at least one fact related to a biomass component of the crop. A fertilizing recipe is determined based on a comparison of the at least one fact related to the grain component of the crop and the at least one fact related to the biomass component of the crop and the fertilizing recipe is executed.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is an exemplary computing system providing a suitable operating environment for the present invention;

FIG. 2 is a flow diagram of the hierarchical operation of generating an optimized recipe for a spatial environment in accordance with an embodiment of the present invention;

FIG. 3 is a flow diagram showing additional details of various acts set forth in the flow diagram of FIG. 2;

FIG. 4 is a flow diagram of updating a recipe for a spatial environment including preparing recipes in stages over a period of time; and

FIG. 5 is a flow diagram showing a method of preparing one or more recipes to optimize the production and harvest of at least one agricultural product in accordance with an embodiment of the present invention.

### DETAILED DESCRIPTION OF THE INVENTION

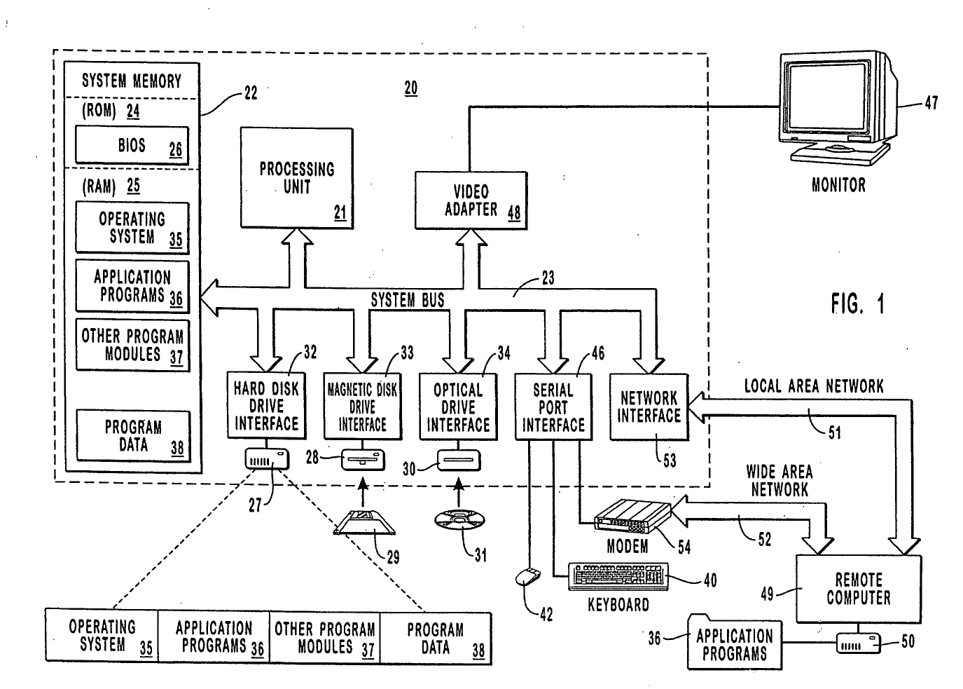

Referring to FIG. 1, an exemplary system is shown that may be used in implementing the present invention. The system includes a general purpose computing device in the form of a computer 20, including a processing unit 21, a system memory 22, and a system bus 23 that couples various system components, including the system memory 22, to the processing unit 21 and effects communication therebetween. The system bus 23 may be any of several types of bus structures including a memory bus or memory controller, a peripheral bus, and a local bus using any of a variety of bus architectures. The system memory 22 may include, for example, read only memory (ROM) 24, random access memory (RAM) 25, flash memory or a combination thereof. A basic input/output system (BIOS) 26, containing the basic routines that help to transfer information between elements within the computer 20, such as during start-up, may be stored in the system memory (e.g., in ROM 24).

The computer 20 may also include a magnetic hard disk drive 27 for reading from and writing to a hard disk, a magnetic disk drive 28 for reading from or writing to a removable magnetic disk 29, and an optical disk drive 30 for reading from or writing to removable optical disk 31 such as a CD-ROM or other optical media. Additional or other storage devices may also be used as will be appreciated by those of ordinary skill in the art. The hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic tapes, flash memory cards, digital versatile disks (DVDs), random access memories (RAMs), read only memories (ROM), and the like, may also be used in the exemplary operating environment.

A number of program modules may be stored on the hard disk, magnetic disk 29, optical disk 31, ROM 24 or RAM 25. Such program modules may include an operating system 35, one or more application programs 36, other program modules 37, and program data 38. A user may enter commands and information into the computer 20 through input devices such as a keyboard 40 and pointing device 42. Other input devices (not shown) may include, for example, a microphone, joy stick, game pad, satellite dish, scanner, or the like. These and other input devices are often connected to the processing unit 21 through an interface 46 that is in communication with the system bus 23. The interface may include, for example, a serial port, a parallel port, a universal serial bus (USB), an Institute of Electrical and Electronics Engineers (IEEE) 1394 port (also known as a FireWire port), a wireless interface or some other interface configured to enable communication and data transfer between an input device and the processing unit 21. A monitor 47 or other type of display device may be connected to the system bus 23 via an interface, such as video adapter 48. In addition to the monitor 47, the computer 20 may include other peripheral output devices (not shown), such as, for example, speakers and printers.

The computer 20 may operate in a networked environment using logical connections to one or more remote computers, such as remote computer 49. Remote computer 49 may be a personal computer, a server, a router, a network PC, a peer device or other common network node, and may include many or all of the elements described above relative to the computer 20, although the remote computer 49 has been illustrated with only a memory storage device 50 in FIG. 1. As depicted in FIG. 1, the logical connections may include a local area network (LAN) 51 and a wide area network (WAN) 52 although other logical connections may be used. Such networking environments are commonplace in offices enterprise-wide computer networks, intranets and the Internet.

When used in a LAN networking environment, the computer 20 may be connected to the local network 51 through a network interface or adapter 53. When used in a WAN networking environment, the computer 20 may include an appropriately configured modem 54 or other means for establishing communications over the wide area network 52, such as the Internet. The modem 54, which may be internal or external, is connected to the system bus 23 via the interface 46. In a networked environment, program modules depicted relative to the computer 20, or portions thereof, may be stored in a remote memory storage device. It will be appreciated that the network connections shown are exemplary and other means of establishing a communications link between the computers may be used.

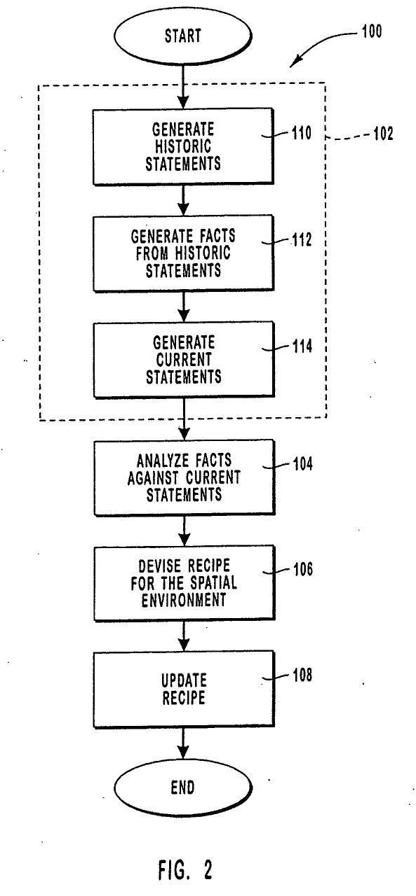

With reference to FIG. 2, an exemplary flow diagram for a hierarchical method of optimizing a recipe for an agricultural spatial environment is depicted generally as 100. As used herein, “spatial environment” is defined to include a region relating to, occupying or having the characteristics of space to which variations occur, in some manner, throughout the space. For example, a spatial environment may include an agricultural site for growing trees, grains, fruits, vegetables or a combination thereof.

Variations which occur throughout the spatial environment are desirably classifiable in some manner in order to be able to obtain tangible data. For example, classifiable variations may include financial, biological, chemical, topographical, meteorological, geographical, geological and other information. As used herein, such classifiable variations may be referred to as modules or subsets of the spatial environment. The total sum of the subsets or modules define the entirety of the spatial environment.

The spatial environment may also be arranged as a compilation of many spatial sites or, for brevity, “sites” through which the modules exist. In other words, a spatial environment may include multiple sites with each site having at least one, and potentially numerous, classifiable variations. Thus, a site may be considered to represent a defined subset of a given spatial environment.

Additionally, as used herein, “recipe” means a formula having various ingredients therein or a set of instructions to be performed. The recipe may be devised for either an individual module, a plurality of modules or for all the modules combined together. The formula or instructions provide a direction for achieving optimization.

It is noted that many of the examples set forth herein are described in terms of an economic optimization. The use of the term economic, and word derivatives thereof, should be considered to include the operation of the agricultural field in a careful, efficient and prudent manner such that financial waste or costs are minimized while benefits are maximized. The term “economic” can accurately be represented by the difference between benefits and costs. Thus, economic optimization is achieved when the costs are relatively small when compared to the benefits. In the context of the module for a fertilizer schedule, such costs may include, for example, the financial costs expended by the farming operation to obtain various blends of fertilizers. Benefits may include, for example, the quantity of crops harvested or the price paid for the quantity of crops harvested. Of course, optimization may be based on other criteria than economic costs and benefits if so desired.

In one embodiment, a process of the present invention may be implemented as a set of computer-executable instructions of a computer-readable medium and which may be read and executed by the computer 20 shown and described with respect to FIG. 1. Of course, the method may be implemented without a computer if so desired.

Specifically, the exemplary process depicted by the flow diagram of FIG. 2 will be described as a method for economically optimizing the fertilizer schedule recipe and the irrigation schedule recipe of an agricultural field. In general, the method includes the generation of a database for the spatial environment as shown at 102, hereinafter referred to as a spatial database. Additionally, the method includes the analysis of the spatial database at step 104. The method also includes the devising of a recipe 106 and, optionally, the updating of the recipe as shown at 108.

The generation of the database 102 comprises the characterization of unknowns, variables and constraints for the spatial environment that is to be managed, i.e., the agricultural field. This may include the generation of historic or current statements and the generation of facts as set forth in greater detail hereinbelow.

As used herein, “statements” may include individual descriptions of one characterization dataset that describes conditions that occur, have occurred or will occur for a specific site. An example of a specific site in an agricultural field, might be a substantially square plot having about 1 meter sides. A site might also be larger and be about 70 feet per side. The site might even be defined as being 1 full acre. A site having about 70 feet per side is a presently useful (and exemplary) site description because conventional VRT fertilizer truck/tractor spreaders for precision farming have booms to distribute the fertilizer which are about 70 feet in length.

A statement for a fertilizer module or an irrigation module may include, for example, the set of soil nutrient parameter values as measured at a specific site. For purposes of illustration, exemplary statements might read: (i) at the first spatial site, the soil nutrients are 42 ppm nitrogen, 32 ppm phosphorous and 21 ppm potassium; and (ii) at the second spatial site the soil nutrients are 44 ppm nitrogen, 32 ppm phosphorous and 19 ppm potassium. It will be appreciated by those of ordinary skill in the art that, for an exemplary agricultural field of about 200 acres having sites that are substantially square and about 70 feet per side, thousands of statements will be generated for the soil types alone. Other examples of statements include, but are not limited to: the soil chemistry; the soil concentrations of micronutrients such as boron, sulphur, and manganese; the soil “physics” such as soil leeching and water capacity; the parameters of the topography of each site; the terrain slope of each site; or the drainage of each site.

The statements generated for use by the fertilizer module may also be used as statements for the irrigation. However, the statements may be interpreted differently when used in conjunction with different activities. More particularly, the statements for use with a fertilizer module may be used to determine how fertilizer should be applied to the spatial environment, whereas the statements used for an irrigation module may be used to determine how the spatial environment should be irrigated. For example, a statement quantifying the amount of nitrogen in the soil may be used by the fertilizer module to devise a recipe calling for more nitrogen. The same statement may be used, at least in part, by the irrigation module to limit the quantity of water applied to the spatial environment in order to limit the amount of nitrogen that is washed away through drainage of the spatial environment.

Many statements may quantify the chemicals in a field or describe weather patterns of a particular area. Statements, however, are not limited to descriptions of data that accumulate over time or that can be measured. Rather, statements may include crop models and other scientific information. In some instances, the statements containing scientific data may be viewed as a constraint. For example current or historical data associated with a given agricultural field may indicate that nitrogen should be added to the soil or that more water is needed. However, a crop model or scientific data may indicate that the particular soil of the agricultural field is only able to accommodate a certain level of nitrogen. This may indicate that it is economically advantageous to add less nitrogen to the fertilizer recipe than would be determined using the historical or current data on its own.

In another example the statements may indicate that a substantial amount of phosphorous is lacking in the soil. However, scientific data may show that the amount of phosphorous that the soil can absorb is limited. Attempting to apply more phosphorous than the soil can absorb is not only economically wasteful, but potentially harmful to the crop. In sum, statements can contain scientific data such as crop models as well as data actually measured and recorded as well as other types of relevant information. It is noted that, in addition to crop models, scientific information can include information relating to plant physiology and growth rates.

Statements may also be described as a set or subset of maps. For example, each agricultural field has many maps associated with it. One map may quantify the nitrogen in the soil while another map describes the type of soil. Other maps may be indicative of weather patterns, evaporation rates or they may contain crop models. The point is that each field has a plurality of maps containing information related to the agricultural field. Each map is divided into spatial sites or sections. The sum of all the information from each map for each spatial site is a statement for the specific site. In other words a statement for a spatial site is the sum of the many maps or layers of data. The spatial database contains all the maps as well as the statements those maps generate.

Statements, such as described hereinabove may be obtained or developed from many and diverse sources. Such sources include, but are not limited to: sensors, both remote and in situ; maps; charts; meteorological monitoring; wind calculations; temperature observations and predictions; relative humidity; crop models; and other related sources. It is noted that each of these sources can produce at least one map.

Statements can be divided into at least two types, historic or current. A historic statement is a statement from a previously occurring condition. A current statement is a statement that describes presently existing conditions. It will be appreciated, however, that the dichotomy between previously and presently occurring conditions are largely defined in relation to one another.

For example, if the soil at a spatial site was tested during the last growing season and was about 41 ppm nitrogen and about 20 ppm potassium, this would be a historic statement in the spatial database. If the soil is tested during the present growing season and is revealed to contain about 46 ppm nitrogen and about 26 ppm potassium, this is a current statement. Yet, a week later the soil composition might actually be different than that expressed in the “current” statement. Because of the impracticality of testing soil at numerous sites all over the agricultural field every few days or hours, current statements remain relative to historic statements. Thus, although the current statement may be a week old (or older) and has actually been “previously” recorded, the current statement will remain as the current statement and the sample from the last growing season will remain as the historic statement. Of course, the statement from the previous week may become another historic statement upon obtaining a new and updated current statement as will be appreciated by those of ordinary skill and the art.

Additionally, statements may be predictive in nature. For example, the expected price of a bushel of wheat (or other crop) for the present growing season might be expected at $3.25 a bushel. Although the wheat has not been sold yet, (or even planted or harvested for that matter), the expected price of wheat may still be entered as a statement.

Still referring to FIG. 2, as shown at 110, historic statements are generated and entered into the spatial database (such as may be contained by the computer 20) by a user. Historic statements for a fertilizer schedule recipe as well as an irrigation recipe may include, for example: tabular data of various fertilizer compositions according to brand, according to price, and/or according to nutrients; soil type classifications from previous growing seasons according to each spatial site in the agricultural field; crop yields from previous growing seasons, in quantity and in price; previous rainfall and water irrigation amounts affecting the previous growing season; information obtained from nearby agricultural fields for previous growing seasons; topography; and any other quantifiable information that may be relevant to the production and harvesting of specified agricultural products.

One particular example of assisting in the generation of statements for soil types present in an agricultural field includes the classifying of soil types that have been collected as a grid pattern of the field representing such samples. Each point of the grid pattern is a spatial site from which soil is collected and then analyzed so that statements can be generated. While it is disputed amongst scholars and agronomists as to what type of grid pattern is most effective when classifying soil types among a given agricultural field, gridding arrangements are generally accepted as being a desirable method for obtaining soil samples in precision agriculture. Once samples are obtained, commercial products are available to assist in predicting how the nutrients in the soil are spatially arranged across the entire field, even from areas of the field where no soil samples were collected. One exemplary product is a Geographic Information System (GIS) software product sold commercially under the name Arc/Info by Environmental Systems Research Institute (ESRI) of California. Using this GIS product, soil data collected from the grid pattern can be interpolated until a map of the soil nutrients is produced for the entire field.

Once the historic statements are generated as shown at 110, the facts are generated from those historic statements as shown at 112. As used herein, “facts” are a set of descriptors condensed from the knowledge of the spatial database as provided by the historic statements. The facts summarize the limits bounding some set of conditions. An example of a fact is a descriptor relating the quantity of crop yield for a given historic statement. Thus, for a plurality of historic statements generated for the numerous recorded soil types at each of the spatial sites throughout the agricultural field, the fact might read that a specific number of bushels of wheat (or other agricultural product) per acre were produced from these soil types. Other facts are similarly generated from the historic statements to represent the knowledge of the spatial data base in an abridged version.

In one exemplary embodiment, facts are generated from the historic statements using artificial intelligence (Al) routines. These Al routines are known to those of ordinary skill in the art and are exemplified in various commercial embodiments. As such, the Al routines and methodologies are not discussed herein in detail.

The first time a recipe is devised for a given spatial environment, data which is useful for generating historical statements may be limited, if available at all. Advantageously, the act of generating facts may alternatively be performed without having any historic statements to begin with. These initial facts may be referred to as “generic” or “fundamental facts” and may include generally accepted data such as, for example, mathematical theorems or known chemical or biological reactions. Fundamental facts may also include things such as current tabular data as used by agronomists.

Thus, fundamental facts may be generated from other sources such as neighboring or regional spatial environments, weather history, newspaper reports, eyewitness accounts and so on. Indeed, data from neighboring spatial environments, such as nearby agricultural fields, would not only be beneficial as a base point but would certainly be directly related and relevant. For example, nearby agricultural fields would be able to furnish valuable rainfall measurements and climatology information since nearby fields often experience substantially similar precipitation and weather patterns throughout the course of a given growing season.

As shown at 114, current statements are also generated for inclusion in the spatial database. Current statements for a fertilizer schedule recipe module or an irrigation schedule recipe module may include, for example: the expected market price or a contractual price for a given crop or other agricultural product; the expected or current market price for given fertilizer blends and various micronutrients; soil type classifications from the present growing season according to each spatial site in the agricultural field; topographical information about each spatial site; water amounts received and predicted for each of the spatial sites; current information obtained from nearby agricultural fields for the present growing season; climate and any other quantifiable information that may be relevant to the production and harvesting of specified agricultural products.

Although the act of generating current statements 114 is illustrated as sequentially following the generation of the facts 112, it should be appreciated that the current statements may be generated at any time during the development of the spatial database. The generation of current statements 114 may precede the generation of the historic statements 10 or facts 112 or may even be generated periodically throughout the development of the spatial database.

Once the spatial database is generated 102, the analysis 104 thereof is performed. As described in further detail below, the analysis 104 occurs generally by making decisions about the facts in light of the current statements 114. Although not depicted, the analysis 104 occurs for a particular module(s) of the spatial environment as may be selected by someone using or implementing the presently disclosed invention. Also, the type of optimization that is desired for a particular module, (i.e., based on time, resources, finances, etc.) may be determined by those implementing the presently disclosed invention. In one exemplary embodiment, the modules may include a fertilizer schedule and an irrigation schedule, wherein the optimization for each module may be based on economics or financial considerations. Once the analysis 104 occurs, a recipe is devised for each module of the spatial environment as shown at 106.

It should be appreciated, however, that the recipe may be provided as a piecemeal or fragmented recipe over time. An example of a piecemeal recipe includes a fertilizer schedule or irrigation schedule optimized for price before the growing season and during the middle of the growing season. Such piecemeal recipe determination is best accomplished when the recipe is updated 108. Although described in other exemplary embodiments set forth hereinbelow, the updating of the recipe is generally the attainment of additional and updated data so that more statements and facts can be generated. Ultimately, this provides a larger spatial database from which the recipe can be improved and further optimized. This is because, as is known, AI routines, expert systems, neural net trains and other similar systems like those having application in the presently disclosed invention are all improved as further knowledge is gained and as trial and error is recognized. Updating 108 is not a requirement for generating a recipe, but may be desirable in many instances.

Additionally, updating 108 of a recipe may take into account unexpected events that may take place over time, or after the initial implementation of a recipe. For example, a first or initial recipe may be developed at some point early in the growing season. While the above-described statements enable a user to develop an optimal initial fertilizer recipe, the initial recipe does not anticipate future events and, thus, does not necessarily remain optimal throughout the growing season. For example, if an irrigation recipe is developed for an agricultural field having six inches of average rainfall and the agricultural field receives ten inches of rain during the growing season, then the irrigation recipe will not result in optimum economic return unless it is updated to compensate for the unanticipated event.

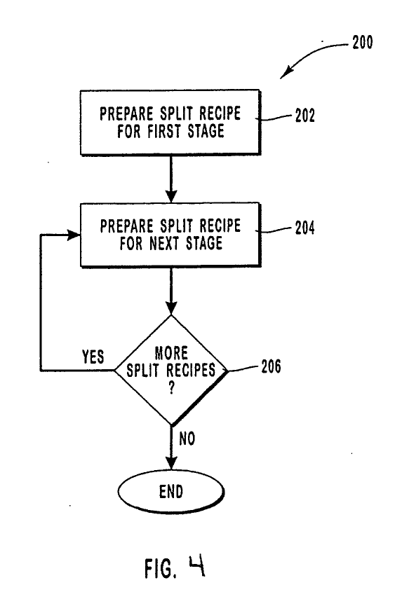

An example of the process or method 200 of updating a recipe to compensate for an unanticipated event is shown in FIG. 4. As shown at 202, an initial or first stage recipe is devised based on initial statements. Development of the initial stage 202 may include generating initial facts and statements for the spatial environment, analyzing the facts to determine whether the facts can be complied with and executed, and devising a recipe for the facts that is within specified constraints. Once the first or initial stage is complete (such as by a passage of a predetermined period of time or by occurrence of a specified event, such as development of a crop plant to a desired level), a second stage recipe is devised as indicated at 204. Preparation of a second stage recipe may be accomplished in a manner similar to the process of devising the first stage recipe. As shown at 206 the process is repeated to prepare continually updated recipes for further stages if such is desired or necessary. Each stage may be separated by a specified period of time, or by the occurrence of an event that is substantially time independent. In one embodiment, the length of time between split applications may be influenced by economic factors. For example, in particular embodiment, a specified time period of approximately four weeks may be used to separate stages.

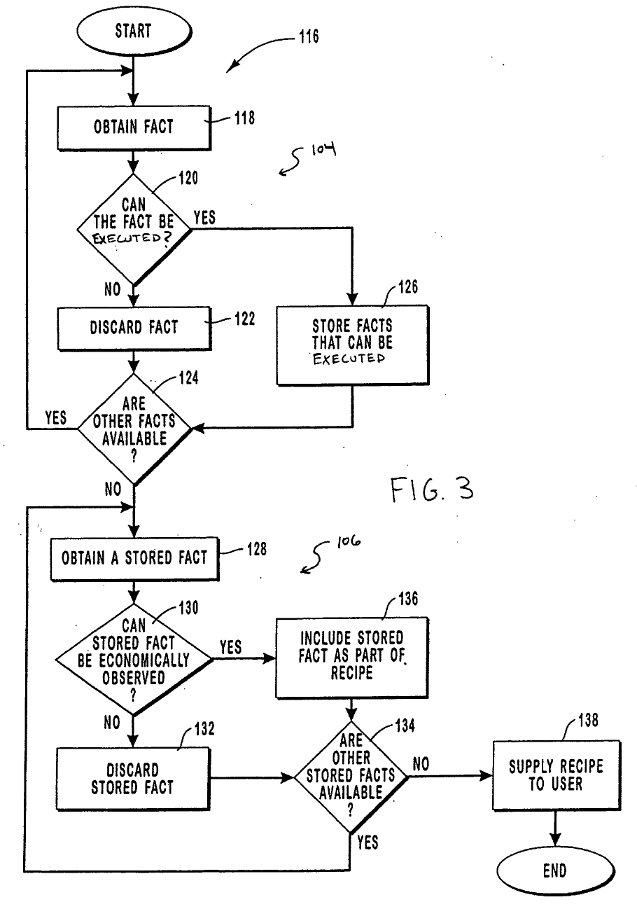

Referring briefly to FIG. 3, the analysis 104 and devising of a recipe 106 for a spatial environment are more fully illustrated in the context of a method 116 of economically optimizing a fertilizer recipe and an irrigation recipe for an agricultural field. The analysis 104 includes obtaining a fact from the spatial database as indicated at 118. A preliminary determination about the obtained fact is made as indicated at 120. The preliminary determination 120 includes examining the fact against the backdrop of the current statements to see if the fact can or cannot be executed.

If the fact cannot be executed, the fact is discarded as shown at 122. An example of non-compliance and discarding a fact is as follows: if the fact states “keep nitrogen below 42 ppm for wheat production” and a current statement indicates that the soil at a particular site in a field for growing wheat is determined to be 46 ppm nitrogen, the fact cannot be executed; the fact is then discarded as indicated at 122. Discarding of the facts in this manner eliminates superfluous data from being considered when the recipe is being devised. Thus, the final recipe is free from extraneous data. Once discarded, the method 116 then ascertains whether other facts are available as shown at 124. If so, the process is repeated until all facts have been examined.

If the fact can be executed, the fact will be stored as indicated at 126. Stored facts, however, should not be deemed to be actually stored as part of the exemplary operating environment on remote or local storage devices. Although the facts could actually be stored, the “stored facts” are merely a means for describing the computer-executable instructions for isolating and/ or maintaining facts until such time as they are further considered as part of the recipe.

As with discarded facts, once a fact is stored as indicated at 126, the method 116 again ascertains whether other facts are available 124. If more facts are available, the steps are iteratively processed until all facts have been exhausted. If no more facts are available, or once all facts have been examined to see if they can be executed, a similar iterative process is invoked for the stored facts. As shown at 128, a stored fact is obtained for a determination as to whether the stored fact can or cannot be economically observed as indicated at 130.

In the context of the costs and benefits, economic observation includes the determination of obtaining the optimized difference between benefits and costs. Thus, for an exemplary one acre farm plot that can produce 100 bushels of wheat without fertilizer and 104 bushels by using a $15.00 bag of fertilizer, the stored fact regarding the purchase of more fertilizer can be economically observed so long as the market price per bushel of wheat will yield a profit for those 4 extra bushels of more than $15.00. In other words, the stored fact is economically observable if the market price is more than $3.75 per bushel. If the market price is such that the price paid for the 4 extra bushels is less than $15.00, the stored fact cannot be economically observed. If the market price is such that the price paid for the extra 4 bushels is exactly $15.00, which equals the price of the bag of fertilizer to achieve those extra bushels, the computer-executable instructions can be arranged to either include the stored fact in the recipe, exclude it, or allow the farming operation to decide.

If the stored fact cannot be economically observed, the stored fact is discarded as indicated at 132. If the stored fact can be economically observed, the stored fact is included in the recipe for that module as indicated at 136. Each stored fact in the recipe may be referred to as an ingredient or an instruction to be performed. As indicated at 134, the analysis process 106 is repeated by inquiring as to whether additional stored facts are available for similar analysis.

It will be appreciated that some stored facts might be better for optimization than other stored facts. For example, one stored fact might indicate that applications of nitrogen will yield an extra 3 bushels of crop per acre. Another stored fact might indicate that additions of phosphorous will yield an extra 3.5 bushels per acre. Although both are economically feasible, the addition of phosphorous may be “more economical” than the addition of nitrogen. In instances such as these, the stored fact providing the best economical optimization takes precedence over the other stored fact.

Once all stored facts have been examined and no other stored facts are available, the determined recipe is provided to the user, as indicated at 138, so that the recipe may be applied to the agricultural field to achieve economic optimization of the fertilizer schedule.

It should be appreciated that, while method 116 has been described as obtaining a single fact and going through the steps of determining compliance, still other routines are available for cycling through all of the facts to determine whether they comply or not with specified constraints. Such other routines include, but are not limited to, multiple looping schemes for simultaneously examining a plurality of facts, assigning a hierarchy of importance to the facts to which only the most important facts are iteratively examined and other similar routines. These routines are also embraced within the scope of the present invention.

The method 116 shown and described with respect to FIG. 3 may also be used to produce an optimized recipe for an irrigation schedule. The difference between the method 116 as applied to an irrigation schedule as opposed to a fertilizer schedule is that one recipe is for the application of fertilizer and the other is for water. Also, the statements, from which the facts are derived may be different. In other words, statements that are relevant to a fertilizer schedule may or may not be relevant for an irrigation schedule. It is noted, however, that many of the statements will be identical. For example, both schedules most likely have statements concerning the topography, yield, drainage, and nitrogen content. Note however, that the facts derived from a similar set of statements are most likely different because of the different type of schedule. This is true for any type of schedule.

It is noted that the present invention may be extended to consider statements and facts relating to the production and harvesting of more than a single agricultural product from a given agricultural field. For example, prior art systems and methods have only focused on harvesting a single component, such as grain from a wheat crop, at the end of a growing season. Indeed, many processes seek to maximize the production of grain, within certain constraints as discussed hereinabove, while actually minimizing the production of other plant components. For example, corn stalks have become shorter in thinner over recent years to minimize the biomass or crop residue that remains after harvesting of the corn. Similarly, wheat stems have become shortened to reduce the crop residue during harvesting of the grain.

However, it has been determined that plant components termed biomass, and often considered to be waste, may be useful in various capacities including, for example, as a renewable fuel source. Thus, there has begun an effort to harvest biomass components of a crop in addition to that of what might be generically termed the “grain” component of a crop. For example, U.S. Pat. No. 6,729,951 to Hoskinson et al. and assigned to the assignee hereof, discusses a method and apparatus for selectively harvesting grain components as well as biomass components of a crop. The disclosure of U.S. Pat. No. 6,729,951 is incorporated in its entirety by reference herein.

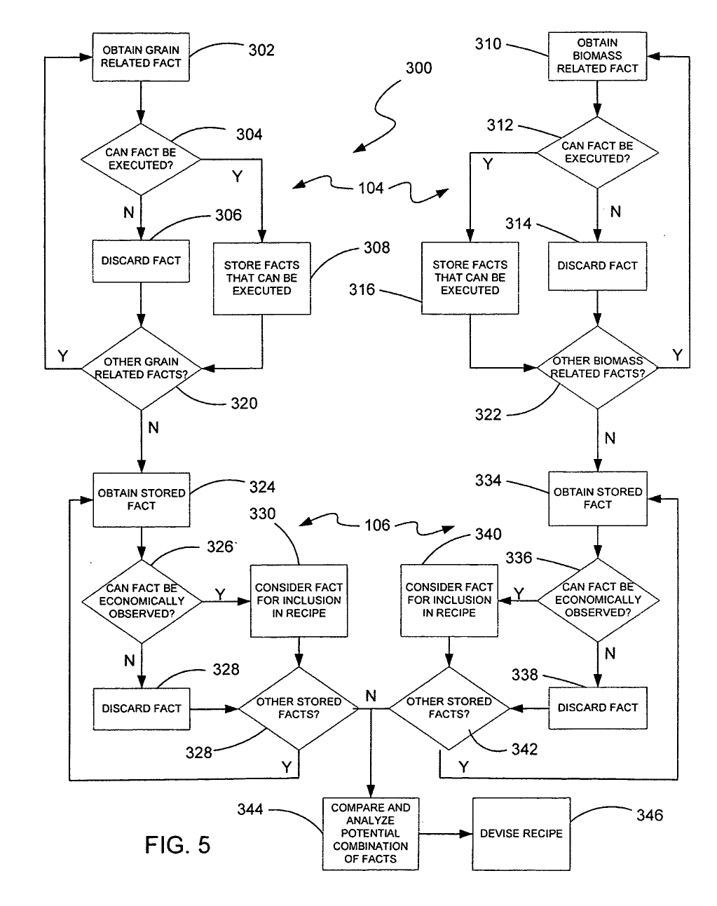

Referring now to FIG. 5, a method 300 of optimizing the production and harvest an agricultural product is shown. The method 300 may be conducted in a manner similar to that of the above-described embodiments of the present invention, but take into account statements and facts related to the production and harvesting of biomass components of a selected crop. The exemplary method 300 generally includes the acts of analyzing facts 104 and devising a recipe for the spatial environment 106. With regard to analyzing facts 104, a fact is obtained related to the production or harvesting of grain, as indicated at 302, and the fact is analyzed to determine whether execution of the fact may be carried out as indicated at 304. If it is not possible to execute the fact, the fact is discarded as indicated at 306. If, however, the fact may be executed, the fact is stored, as indicated at 308, for use in deriving a recipe.

A similar process may take place with respect to analyzing facts related to the production of a biomass component such as the stems or straw of a crop plant. Thus, a fact is obtained regarding the production and/or harvesting of a biomass component as indicated at 310. The biomass related fact may be analyzed to determine the feasibility of executing the fact as indicated at 312. If it is not possible to execute the fact, the fact is discarded as indicated at 314. If, however, the fact may be executed, the fact is stored, as indicated at 316, for use in deriving a recipe. The process is iterative for both grain related facts and biomass related facts as indicated at 320 and 322.

A stored grain fact is obtained, as indicated at 324, for a determination as to whether the stored grain fact can or cannot be economically observed as indicated at 326. If the stored grain fact cannot be economically observed, the stored grain fact is discarded as indicated at 328. If the stored grain fact can be economically observed, the stored fact is considered for inclusion in the recipe for that module as indicated at 330. Each grain fact that ultimately becomes a part of the recipe may be referred to as an ingredient or an instruction to be performed. As indicated at 332, the analysis process 106 is repeated by inquiring as to whether additional stored facts are available for similar analysis.

A stored biomass fact is similarly obtained, as indicated at 334, for a determination as to whether the stored biomass fact can or cannot be economically observed as indicated at 336. If the stored biomass fact cannot be economically observed, the stored biomass fact is discarded as indicated at 338. If the stored biomass fact can be economically observed, the stored fact is considered for inclusion in the recipe for that module as indicated at 340. Each biomass fact that ultimately becomes a part of the recipe may be referred to as an ingredient or an instruction to be performed as indicated at 342, the analysis process 106 is repeated by inquiring as to whether additional stored facts are available for similar analysis.

The economically observable grain facts and economically observable biomass facts may further be analyzed to determine whether an emphasis should be placed on executing instructions associated with one type of fact or another (i.e., grain vs. biomass) as indicated at 344. Thus, for example, if constraints indicate that production of biomass components is more economically desirable than production of grain components, an emphasis may be placed on executing any instructions associated with a stored biomass fact, even to the exclusion of executing instructions associated with stored grain facts in certain situations. After making such an analysis, a recipe is devised based on the comparison and analysis of economically observable facts as indicated at 346.

Various scenarios may be considered in showing more specific examples of implementing the method 300 described with respect to FIG. 5. In one scenario, grain may be selling for, or predicted to sell for, $3.00 per bushel while a biomass component, such as straw, may be selling for, or predicted to sell for, $10.00 per ton. Using this information, recipes for fertilizing, irrigation, application or pesticide or some other activity may be generated to most economically produce grain, a biomass component, or a combination of both components.

In another scenario, grain may be selling for, or predicted to sell for, $2.50 per bushel while a biomass component, such as straw, may be selling for, or predicted to sell for, $50.00 per ton. In such a scenario it would be desirable to produce a recipe that would enhance the production of biomass components as compared to a recipe associated with the first-described scenario.

As discussed hereinabove, a recipe may be updated at various times and based on various factors or events. Thus, for example, if a crop was initially planted using predicted information (e.g., $3.00/bushel grain and $10.00/ton biomass) and such information was later altered (e.g., to $2.50/bushel grain and $50.00/ton biomass), the recipe may be updated at an appropriate time during the growing season to optimize production of grain, biomass or both as may be determined by the method 300 of the presently disclosed invention.

Of course, as with the other embodiments disclosed hereinabove, both current and historical statements may be valuable in practicing the method 300 of optimizing the production and harvest an agricultural product. For example, production of a grain component, a biomass component, or both, as effected by application of a previous recipe (whether it be a fertilizer recipe, an irrigation recipe or some other recipe) would be valuable information in practicing the presently disclosed method. As previously mentioned, in situations where historic statements are sparse or even completely unavailable, fundamental facts or assumptive information may be initially used and historic statements generated and gathered over a period of time.

In general, the method 300 described with respect to FIG. 5, may be termed as identifying to different plant components of a crop (e.g., a grain component and a straw component) and optimizing the production and harvest of the two components based on information known or predicted about such components. Thus, the optimization may include enhancing production of one component to the detriment of another component, or it may include finding a balance in the production of the two components. Such a method provides a farming operation considerable flexibility in a market of fluctuating prices, particularly since more than one component of a given crop may be selectively produced and harvested as opposed to the prior art methods of simply trying to optimize production and harvesting of a single component (e.g., grain).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A method of producing and harvesting an agricultural crop, the method comprising:
identifying a first crop component for potential production and harvesting;
identifying at least a second crop component for potential production and harvesting;
analyzing at least one fact related to production and harvesting of the first crop component and at least one fact related to production and harvesting of the at least a second crop component; and
selectively optimizing the production of the first crop component and the at least a second crop component based on the analysis by determining a recipe for application to the agricultural crop.

2. The method according to claim 1, wherein the identifying a first crop component includes identifying a grain component of the crop and wherein the identifying at least a second crop component includes identifying a biomass component of the crop.

3. The method according to claim 2, wherein the analyzing at least one fact related to production and harvesting of the first crop component and at least one fact related to production and harvesting of the at least a second crop component includes analyzing a current market price of the grain component and a current market price of the biomass component.

4. The method according to claim 2, wherein the analyzing at least one fact related to production and harvesting of the first crop component and at least one fact related to production and harvesting of the at least a second crop component includes analyzing a predicted market price of the grain component and a predicted market price of the biomass component.

5. The method according to claim 2, wherein determining a recipe includes determining a fertilizer recipe for application to the agricultural crop.

6. The method according to claim 2, wherein the determining includes determining an irrigation recipe for application to the agricultural crop.

7. The method according to claim 1, further comprising:
updating the at least one fact related to production and harvesting of the first crop component;
updating the at least one fact related to the production and harvesting of the at least a second crop component;
analyzing the at least one update fact related to production and harvesting of the first crop component and the at least one updated fact related to the production and harvesting of the at least a second crop component; and
updating the recipe for application to the agricultural crop.

8. The method according to claim 1, wherein the analyzing at least one fact related to production and harvesting of the first crop component and at least one fact related to production and harvesting of the at least a second crop component includes generating the at least one fact related to production and harvesting of the first crop component from at least one historical statement.

9. The method according to claim 8, wherein the analyzing at least one fact related to production and harvesting of the first crop component and at least one fact related to production and harvesting of the at least a second crop component further includes generating the at least one fact related to the production and harvesting of the at least a second crop component from the at least one historical statement.

10. The method according to claim 8, wherein the analyzing at least one fact related to production and harvesting of the first crop component and at least one fact related to production and harvesting of the at least a second crop component further includes generating the at least one fact related to the production and harvesting of the at least a second crop component from at least one other historical statement.

11. The method according to claim 8, wherein the at least one historical statement includes information relating to a specific site of an agricultural field associated with the agricultural crop.

12. The method according to claim 8, wherein the analyzing at least one fact related to production and harvesting of the first crop component and at least one fact related to production and harvesting of the at least a second crop component further includes generating the at least one fact related to production and harvesting of the first crop component from at least one current statement in conjunction with the at least one historical statement.

13. The method according to claim 1, wherein the analyzing at least one fact related to production and harvesting of the first crop component and at least one fact related to production and harvesting of the at least a second crop component includes generating the at least one fact related to production and harvesting of the first crop component from at least one current statement.

14. The method according to claim 13, wherein the analyzing at least one fact related to production and harvesting of the first crop component and at least one fact related to production and harvesting of the at least a second crop component further includes generating the at least one fact related to the production and harvesting of the at least a second crop component from the at least one current statement.

15. The method according to claim 13, wherein the analyzing at least one fact related to production and harvesting of the first crop component and at least one fact related to production and harvesting of the at least a second crop component further includes generating the at least one fact related to the production and harvesting of the at least a second crop component from at least one other current statement.

16. The method according to claim 13, wherein the at least one historical statement includes information relating to a specific site of an agricultural field associated with the agricultural crop.

17. A method of producing and harvesting an agricultural crop, the method comprising:
obtaining at least one fact related to a first component of the crop;
preparing a first analysis regarding whether a defined action associated with the at least one fact related to the first component may be executed;
obtaining at least one fact related to a second component of the crop;
preparing a second analysis regarding whether a defined action associated with the at least one fact related to the second component may be executed;
comparing the first analysis with the second analysis; and
determining an action to be taken with respect to the agricultural crop based on the comparing the first analysis with the second analysis.

18. The method according to claim 17, wherein the obtaining at least one fact related to a first component of the crop includes obtaining at least one fact related to a grain component of the crop and wherein the obtaining at least one fact related to a second component of the crop includes obtaining at least one fact related to a biomass component of the crop.

19. The method according to claim 17, wherein the determining an action to be taken with respect to the agricultural crop based on the comparing the first analysis with the second analysis includes providing a recipe to enhance production of the first component of the crop.

20. The method according to claim 19, wherein the providing a recipe includes providing a fertilizer recipe.

21. The method according to claim 19, wherein the providing a recipe includes providing an irrigation recipe.

22. A method of producing and harvesting an agricultural crop, the method comprising:
obtaining at least one fact related to a grain component of the crop;
obtaining at least one fact related to a biomass component of the crop;
determining a fertilizing recipe based on a comparison of the at least one fact related to the grain component of the crop and the at least one fact related to the biomass component of the crop; and
executing the fertilizing recipe.

23. The method according to claim 22, further comprising:
updating the at least one fact related to a grain component of the crop;
updating the at least one fact related to a biomass component of the crop;
updating the fertilizing recipe based on a comparison of the at least one updated fact related to the grain component of the crop and the at least one updated fact related to the biomass component of the crop; and
executing the updated fertilizing recipe.

24. The method according to claim 22, further comprising determining an irrigation recipe based on a comparison of the at least one fact related to the grain component of the crop and the at least one fact related to the biomass component of the crop and executing the irrigation recipe.
